(19) United States
(12) Patent Application Publication
(10) Pub. No.: US 2018/0334551 A1
(43) Pub. Date: Nov. 22, 2018

(54) SURFACE FUNCTIONALIZED HOLLOW SILICA PARTICLES AND COMPOSITES

(71) Applicant: KING ABDULLAH UNIVERSITY OF SCIENCE AND TECHNOLOGY, THUWAL (SA)

(72) Inventors: Valentin RODIONOV, Thuwal (SA); Vu Bao KHANH, Thuwal (SA)

(73) Assignee: KING ABDULLAH UNIVERSITY OF SCIENCE AND TECHNOLOGY, THUWAL (SA)

(21) Appl. No.: 15/775,341

(22) PCT Filed: Nov. 10, 2016
(86) PCT No.: PCT/IB2016/001702

§ 371 Date: May 10, 2018

Related U.S. Application Data
(60) Provisional application No. 62/258,271, filed on Nov. 20, 2015.

(51) Int. Cl. C08K 7/26; C08K 9/06; C08K 3/36; C08J 5/24

(52) U.S. Cl. CPC C08K 7/26; C08K 9/06; C08K 3/36; C08J 2363/00; C08K 2201/005; C08K 2201/011; C08J 5/24

(57) ABSTRACT

Composition comprising hollow spherical silica particles having outside particle walls and inside particle walls, wherein the particles have an average particle size of about 10 nm to about 500 nm and an average wall thickness of about 10 nm to about 50 nm; and wherein the particles are functionalized with at least one organic functional group on the outside particle wall, on the inside particle wall, or on both the outside and inside particle walls, wherein the organic functional group is in a reacted or unreacted form. The organic functional group can be epoxy. The particles can be mixed with polymer precursor or a polymer material such as epoxy to form a prepreg or a nanocomposite. Lightweight but strong materials can be formed. Low loadings of hollow particles can be used.

### BACKGROUND

A variety of materials have been applied as interphase between reinforcing fibers and resins in composite materials including rare earth salts, graphite, carbon nanotubes, carbonaceous materials, polymers and core-shell particles. Silica nanoparticles have been known to increase modulus of resin or of fiber-reinforced polymers, and subsequently, compressive properties of the composite materials. However, a very high loading (>10 wt. % is commonly needed). This increases the weight of the composite due to high density of silica. For most applications, such weight increase is undesirable.

A need exists for new additives that could improve resin modulus without penalizing its weight. For example, a particularly important example is the epoxy-silica composite system. See, for example, Bondioli et al, J. Appl. Polym. Sci., 97, 6, 2382-2386 (2005) for silica-epoxy nanocomposites.

Wang et al. (Adv. Mat. Dev. Per., 6, 2012, 601) describes hollow and functionalized silica/magnetic nanocomposite particles which can be combined with epoxy resin. However, the materials must be magnetic and no analysis of mechanical properties is described for the composite.

US patent publication 2015/0056438 describes hollow silica particles. However, the materials must include phenyl groups and no analysis of mechanical properties is described for the composite.

U.S. Pat. No. 7,781,060 describes hollow silica particles which can be used with polymers in composites. However, the description of how to functionalize such particles is limited.

### SUMMARY

Aspects and embodiments provided herein include, for example, composition, materials, devices, and articles, and methods of making and using the same.

A first aspect provides, for example, a composition comprising hollow, substantially spherical silica particles having outside particle walls and inside particle walls, wherein the particles have an average particle size of about 10 nm to about 500 nm and an average wall thickness of about 5 nm to about 50 nm; and wherein the particles are functionalized with at least one organic functional group on the outside particle wall, on the inside particle wall, or on both the outside and inside particle walls, wherein the organic functional group is in a reacted or unreacted form.

In one embodiment, the particles are functionalized with the organic functional group on the outside particle wall but not the inside particle wall. In one embodiment, the particles are functionalized with the organic functional group on the inside particle wall but not the outside particle wall. In one embodiment, the particles are functionalized with the organic functional group on both the outside particle wall and the inside particle wall.

In one embodiment, the particles are functionalized with the organic functional group on both the outside particle wall and the inside particle wall and the organic functional group is the same for the outside and the inside particle walls. In one embodiment, the particles are functionalized with the organic functional group on both the outside particle wall and the inside particle wall and the organic functional group on the outside particle wall is different than the organic functional group on the inside particle wall.

In one embodiment, the organic functional group is a reactive functional group or an unreactive functional group. In one embodiment, the organic functional group is a reactive functional group. In one embodiment, the organic functional group is an unreactive unreactive group. In one embodiment, the organic functional group is a reactive functional group but is in an unreacted form. In one embodiment, the organic functional group is a reactive functional group and is in a reacted form.

In one embodiment, the organic functional group comprises a nitrogen or oxygen atom. In one embodiment, the organic functional group is epoxy, primary amino, secondary amino, imidazole, methacrylate, acrylate, urea, or fluorocarbon. In one embodiment, the organic functional group is an amino or epoxy group. In one embodiment, the organic functional group is a fluorocarbon group. In one embodiment, the organic functional group is covalently linked to the silica with a bivalent alkylene spacer. In one embodiment, the organic functional group is covalently linked to the silica with a bivalent ethylene or propylene spacer.

In one embodiment, the average wall thickness is about 10 nm to about 40 nm. In one embodiment, the average particle size is about 25 nm to about 250 nm. In one embodiment, the average particle size is about 50 nm to about 125 nm.

In one embodiment, the composition further comprises at least one polymer precursor or polymer material. In one embodiment, the composition further comprises at least one polymer precursor or polymer material which is in final form. In one embodiment, the composition further comprises at least one polymer precursor or polymer material which is in uncured form. In one embodiment, the composition further comprises at least one polymer precursor or polymer material in which the polymer is a thermoplastic or a thermosetting polymer precursor or polymer material. In one embodiment, the composition further comprises at least one polymer precursor or polymer material in which the polymer is an epoxy, polyurethane, polyimide, polyacrylate, polymethacrylate, polystyrene, or phenolic resin. In one embodiment, the composition further comprises at least one epoxy polymer precursor or epoxy polymer material. In one embodiment, the composition further comprises at least one hardener and/or curing agent.

In one embodiment, the composition further comprises at least one polymer precursor or polymer material, wherein the amount of the silica in the composition is about 10 wt. % or less. In one embodiment, the composition further comprises at least one polymer precursor or polymer material, wherein the amount of the silica in the composition is about 5 wt. % or less.

In one embodiment, the particles before mixing with the polymer precursor or polymer material have a surface area of at least 150 m²/g, a pore volume of at least 0.5 cm³/g, and a pore size of at least 25 nm in nitrogen sorption testing.

A second aspect provides, for example, a composite comprising at least one polymer material and hollow, substantially spherical silica particles having outside particle walls and inside particle walls, wherein the particles have an average particle size of about 10 nm to about 500 nm and an average wall thickness of about 5 nm to about 50 nm; and wherein the particles are functionalized with at least one organic functional group on the outside particle wall, on the inside particle wall, or on both the outside and inside particle walls, wherein the organic functional group is a reactive or unreactive functional group but is in a reacted form if a reactive functional group.

In one embodiment, the particles are functionalized with the organic functional group on the outside particle wall but not on the inside particle wall. In one embodiment, the particles are functionalized with the organic functional group on the inside particle wall but not on the outside particle wall. In one embodiment, the particles are functionalized with the organic functional group on both the outside particle wall and the inside particle wall. In one embodiment, the particles are functionalized with the organic functional group on both the outside particle wall and the inside particle wall and the organic functional group is the same for the outside and the inside particle walls. In one embodiment, the particles are functionalized with the organic functional group on both the outside particle wall and the inside particle wall and the organic functional group on the outside particle wall is different than the organic functional group on the inside particle wall.

In one embodiment, the average wall thickness is about 10 nm to about 40 nm, and the average particle size is about 25 nm to about 250 nm.

In one embodiment, the amount of the silica in the composite is about 10 wt. % or less. In one embodiment, the amount of the silica in the composite is about 5 wt. % or less. In one embodiment, the amount of the silica in the composite is at least 5 wt. % but the density of the composite is less than 1.2 g/cm³.

A third aspect provides for a composition consisting essentially of: hollow, substantially spherical silica particles having outside particle walls and inside particle walls, wherein the particles have an average particle size of about 10 nm to about 500 nm and an average wall thickness of about 5 nm to about 50 nm; and wherein the particles are functionalized with at least one organic functional group on the outside particle wall, on the inside particle wall, or on both the outside and inside particle walls, wherein the organic functional group is in a reacted or unreacted form.

In one embodiment, the composition consists of the hollow, substantially spherical silica particles having outside particle walls and inside particle walls, wherein the particles have an average particle size of about 10 nm to about 500 nm and an average wall thickness of about 5 nm to about 50 nm; and wherein the particles are functionalized with at least one organic functional group on the outside particle wall, on the inside particle wall, or on both the outside and inside particle walls, wherein the organic functional group is in a reacted or unreacted form

Other embodiments include a prepreg composition comprising the compositions as described and/or claimed herein.

Other embodiments include a method of making the composition comprising the particles as described and/or claimed herein, the method comprising making the particle(s) by a core-shell templating route.

Other embodiments include an article comprising the composition comprising the particles as described and/or claimed herein.

A variety of advantages can flow from one or more embodiments of the claimed inventions. For example, in at least some embodiments, enhanced properties such as Young's Modulus, fracture energy and toughness of resin can be achieved while maintaining intrinsic properties of the resin (e.g., glass transition temperature). In addition, for at least some embodiments, much lower weight loading (at least half, for example) can be achieved to achieve the same modulus in a composite. In at least some embodiments, energy can be saved due to light weight. In at least some embodiments, good dispersability or dispersion stability can be achieved.

### BRIEF DESCRIPTION OF THE DRAWINGS

FIG. 1 illustrates general scheme of a composite material comprising functionalized hollow spherical particles (shown in three embodiments, A, B, and C).

FIG. 2 provides TEM images of epoxy-functionalized hollow organosilica particles with external diameter of 64 nm (left) and 100 nm (right).

FIG. 3 provides an SEM image of epoxy-functionalized hollow organosilica particles with external diameter of 100 nm.

FIG. 4 illustrates SEM image of nanocomposite material (comprising epoxy loaded with 1% hollow organosilica with external diameter of 64 nm).

FIG. 5 illustrates a TEM image of an ultra-thin layer of the composite that demonstrates that the particles indeed remain hollow when mixed with polymer.

FIG. 6 illustrates a graph showing density of three composite materials as a function of silica loading for three different types of composite.

FIG. 7 illustrates stability of particles in epoxy/hardener after standing overnight. Hollow silica/epoxy is on the left and commercial Ludox on the right.

FIG. 8 illustrates modulus, tensile strength, and glass transition temperature of epoxy/hardener loaded with various amounts of commercial solid silica.

FIG. 9 illustrates modulus, tensile strength, and glass transition temperature of epoxy/hardener loaded with various amounts of hollow organosilica with diameter of 64 nm.

FIG. 10 illustrates modulus, tensile strength, and glass transition temperature of epoxy/hardener loaded with various amounts of hollow organosilica with diameter of 100 nm.

FIG. 11 illustrates nitrogen isotherm data. The left plot shows an isotherm plot, whereas the right plot shows pore size distribution.

FIG. 12 illustrates IR and Raman analysis of composites.

FIG. 13 illustrates additional mechanical testing at low loading of HOSiSiO₂.

### DETAILED DESCRIPTION

### Introduction

All references cited herein are incorporated by reference in their entirety.

In embodiments described and claimed herein, the open-ended terms “comprising” or “comprises” can be replaced by the partially closed term “consisting essentially of” or the closed term “consisting of.”

The various elements of the multiple aspects summarized above and other embodiments described and claimed herein are described in more detail herein below.

### Composition

Compositions described herein can be precursor compositions, capable of reaction (“reactive compositions”), or “final compositions.” For example, a monomer precursor composition can be converted with polymerization reaction to a final polymer composition, often in the presence of the particles. Alternatively, a final composition can be provided from a polymer, such as a thermoplastic polymer, which is mixed with the particles but is not polymerized. The thermoplastic polymer can be, for example, heated as part of mixing. Some chemical reaction, however, may occur between the particles and the polymer for either situation.

Compositions including composites and nanocomposites are known in the art which comprise two or more materials mixed together. In many cases, one material will be a polymer or resin, whether in the precursor or final form. The materials can be unreacted, partially reacted, or fully reacted. Another component is often used to enhance properties of the polymer or resin. These can be, for example, reinforcement fibers. Particles and fibrous materials can be used.

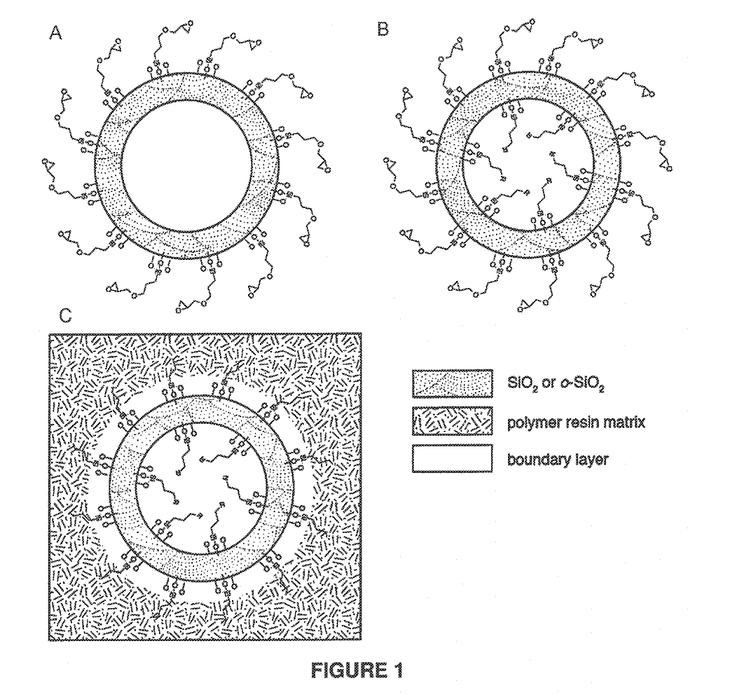

FIGS. 1(A), (B), and (C) illustrate some embodiments of the claimed inventions. In FIG. 1A, the particle is functionalized with an organic functional group on the outer wall but not the inner wall of the hollow particle, whereas in FIG. 1B, the particle is functionalized on the outer wall and the inner wall of the hollow particle. The reactive functional group bound to the particle is an epoxy group with a spacer. It is shown in FIGS. 1A and 1B in unreacted form. FIG. 1C shows the particle of FIG. 1B in a polymer resin matrix and also shows the boundary layer at the interface of the particle and the polymer resin matrix. The organic functional group can react with the polymer resin matrix as shown in FIG. 1C and it is shown in reacted form.

FIG. 1, while idealized, shows the substantially spherical form of the particle as well as the inner wall surface, the outer wall surface, and the wall thickness. One can measure the average particle size and the average wall thickness. In general, monodisperse, uniform particle mixtures are desired.

The composition, when it is in a liquid or precursor form, can also comprise one or more solvents, including organic solvents to help reduce viscosity if desired. Examples of solvents include organic solvents such as acetone, denatured alcohol, toluene, or any suitable organic solvent. The composition also can be heated to reduce viscosity.

The composite composition can also have fibers and reinforcing fibers.

### Particles

The particles described herein can comprise silica, or ethyl-bridged organosilica, are hollow, are generally or substantially spherical, and are nanoscale. The sphericity of the particles can be close to one, for example, at least 0.90 or at least 0.95, or at least 0.98.

In a preferred embodiment, the particles comprise, consist essentially of, or consist of only silicon and oxygen to form silica, and then also carbon and hydrogen to form ethyl-bridged silica. In the preferred embodiment, no other elements are present, or if they are present, they are present in small amounts such as, for example, less than 5 wt. %, or less than 1 wt. %. In a preferred embodiment, for example, the particles are not magnetic and no elements such as a metal such as cobalt which provide magnetic character are present at any meaningful level. The particles can also be free of organic polymer before the particles are mixed with an organic polymer to form a composite. The Wang article, described above, describes hollow magnetic particles based on silica/cobalt ferrite which are prepared by a template approach.

The particles can be characterized by an average diameter of, for example, about 10 nm to about 500 nm, or about 10 nm to 100 nm, or about 10 nm to 50 nm, or about 25 nm to about 250 nm, or about 50 nm to about 150 nm. The particle diameter can be measured by, for example, TEM or SEM methods as known in the art. The outer wall of the particle is used for the diameter measurement. In many cases, the high surface area to volume ratio is desired which comes with smaller particle sizes. Use of larger particles, or particles having relatively thin walls, can lead to potentially more brittle materials.

The hollow particles also can be characterized by a wall thickness which can be, for example, about 5 nm to about 50 nm, or about 10 nm to about 40 nm, or about 20 nm to about 40 nm.

The ratio of the particle diameter to the particle wall thickness can be, for example, about 5:1 to 25:1, or about 7.5:1 to 15:1, or about 9:1 to 11:1.

Conventional geometry formulae can be used to calculate the volume of the sphere, the volume of the hollow void, the volume of the solid with a certain wall thickness, the mass of the overall particle with a certain wall thickness, the number of particles per gram, and the surface area of one particle. The calculations can be compared with experimental data such as the BET surface area and the pore volume obtained by nitrogen sorption. Good agreement in general was obtained between the calculations and the measurements.

In some embodiments, the hollow particles are not filled with polymer. In other embodiments, the hollow particles are partially or fully filled with polymer.

Often, one desires that no air is trapped in the particles. In other embodiments, however, air can be trapped in the particles (e.g., with fluorous functionalization of the inside surfaces).

In a preferred embodiment, the wall of the particle is a single layer wall and not a double layer wall. PCT/US2013/026745 describes a double layer particle wall.

### Organic Functional Group

The particles can be functionalized with one or more organic functional groups which are selected for their reactivity with, or for their affinity or phobicity towards another component in the composition such as, for example, the monomers in a plastic or resin formulation. Organic functional groups are known in the art as a specific collection of atoms which are recognized to give characteristic properties and/or reactivities.

The organic functional group can be a reactive group or an unreactive group. Examples of reactive groups include amino or epoxy, whereas an example of an unreactive group can be a fluorocarbon or alkyl group. The reactive nature of the group in this distinction is determined by recognized, conventional organic synthesis conditions for conducting useful reactions, not extreme conditions such as combustion temperatures.

The functional groups can be present on the outer wall of the particle and/or the inner wall of the particle. If the functional groups are present in both the outer and inner walls, they can be the same or different.

Examples of functional groups include epoxy, amine (both primary and secondary), methacrylate, acrylate, urea, or a fluorocarbon including C4-C10 fluorocarbons. Fluorocarbon groups can be partially fluorinated or perfluorinated. Examples include the monovalent structure —(CX₂)_{z}CF₃, wherein X can be independently hydrogen or fluorine and z can be 3-9. In some embodiments, all X moieties are fluorine.

Often, the functional group can be covalently linked to the silica via reaction of a trifunctional silane group as known in the art for coupling agents. The trifunctional silane in many cases can be represented by FG-Sp-Si, wherein FG is the organic functional group, Sp represents a bivalent spacer, and Si represents the trifunctional silane which can hydrolyze and covalently link the spacer and the functional group to a larger structure. An alternative representation is RSiX₃, wherein R is an organic group which can comprise the organic functional group and X represents hydrolysable groups such as methoxy, ethoxy, or chloro.

The bivalent spacer can be, for example, a C₂-C₁₀, or C₂-C₅, or C₂-C₃ bivalent spacer such as bivalent ethylene or bivalent propylene spacer. The ethylene spacer generally is more easily found to be commercially available.

The Si trifunctional silane can be as known in the art —Si(OR)₃ such as —Si(OMe)₃ or —Si(OEt)₃. The goal is to allow for hydrolysis and condensation (forming —Si—O—Si— siloxane bonds) so that the silane, with its organic moiety, becomes part of a larger molecular network.

The organic functional group can comprise an oxygen or nitrogen heteroatom. It can also include ethylenic unsaturation.

Particular examples of silanes include: trimethoxy[2-(7-oxabicyclo[4.1.0]hept-3-yl)ethyl]silane; (3-glycidoxypropyl)trimethoxysilane, (3-glycidyloxypropyl)triethoxysilane; 3-trimethoxysilylpropylurea; bis(3-trimethoxysilylpropyl)amine; triethoxy-[3-(2-imidazolin-1-yl)propyl]silane; 3-aminopropyltriethoxysilane; 2-aminoethyl-[2-(3-trimethoxysilylpropylamino)ethyl]amine; 2-aminoethyl(3-trimethoxysilylpropyl)amine; aminopropylmethydiethoxy silane; 3-(trimethoxysilyl)propyl methacrylate; 3-aminopropyldimethylmethoxysilane; or any long-chain fluorocarbon triethoxysilanes.

If the desired mode of functionalization is outside only, or different functionalities are required inside and outside the shell, the particles can be prepared by core-shell template processes. Here, a first round of functionalization is performed before the removal of the internal template. The template is removed, and the internal surface of the sphere is functionalized if needed.

In one embodiment, the inner wall is functionalized with an unreactive functional group, such as fluorocarbon, but the outer wall is functionalized with a reactive functional group.

In one embodiment, the organic functional group is not an organic functional group as described in Lim 2015/0056438 and in particular is not a phenyl group.

### Polymer

Polymer composites are known in the art including polymer-silica composites and epoxy-silica composites. The polymer upon cure can have a glass transition of, for example, greater than 25° C., greater than 50° C., greater than 75° C., or greater than 100° C. Polymers (including polymer precursors, monomers, oligomers) and different kinds of polymers (including thermoplastic and thermosetting polymers) are known in the art. See, for example, Billmeyer, Textbook of Polymer Science, 3^{rd} Ed., 1984. Epoxy resins and polyurethanes, for example, are discussed and known in the art. See also Allcock and Lampe, Contemporary Polymer Chemistry, 1981.

The particles can be mixed with polymer precursors, including monomers and oligomers, and polymers. The polymer can be called a matrix.

The polymer can be prepared from separate components including the resin and hardener. These components can be mixed to start reaction.

Examples include epoxide resin including resins of bisphenol A diglycidyl ether (DGEBA), di-Glycidyl Ether of Bisphenol F (DGEBF), tetraglycidyl 4,4′-diaminodiphenylmethane (TGDDM), and bisphenol A (BPA), and also polyurethane, whether thermoplastic or thermoset, polyimide, polyacrylate, polymethacrylate, polystyrene, and phenol resin, and the like.

A hardener or curing agent also can be used as known in the art. Examples include:

(i) Amines: such as aliphatic and cycloaliphatic amines: piperidine, 4,4′-methylene bis(2-methylcyclohexylamine, diethylenetriamine, isophorone diamine, N,N-dimethylpiperidine, triethylenediamine, 2,4,6 tris(dimethylaminomethyl) phenol, benzyldimethylamine, 2-(dimethylaminomethyl) phenol poly(ether amine); aromatic amines: 4,4′-methylenebis(2,6-diethylaniline), 4,4′-methylenebis(2,6-dimethylaniline), 3-aminophenyl sulfone, 4-aminophenyl sulfone; polyamide resin;

(ii) Imidazoles: such as 2-methylimidazole, 2-ethyl-4methylimidazole, 1-cyanoethyl-2-undecylimidazolium trimellitate, Epoxy-imidazole adduct. Imidazoles can be used as a curing accelerator or co-curing agent for organic-acid anhydrides, dicyandiamine, polyhydric phenol, and aromatic amine;

(iii) Anhydrides: including aromatic anhydrides, alicyclic anhydrides, aliphatic anhydrides, hexahydro-4-methylphthalic anhydride, methyltetrahydrophthalic anhydride, methyl-5-norbornene-2,3-dicarboxylic anhydride, phthalic anhydride, trimellitic anhydride, pyromellitic anhydride, benzophenone tracarboxylic anhydride, ethylene glycol bistrimellitate, glycerol tristrimellitate, maleic anhydride, tetrahydrophthalic anhydride, methyltetrahydrophthalic anhydride, endomethylene tetrahydrophthalic anhydride, methylendomethylene tetrahydrophthalic anhydride, methylbutenyl tetrahydrophthalic anhydride, dodecenyl succinic anhydride, hexahydrophthalic anhydride, succinic anhydride, methylcyclohexene dicarboxylic anhydride, alkylstyrene-maleic anhydride copolymer, chlorendic anhydride, polyazelaic polyanhydride;

(iv) Latent curing agents: boron trifluoride-amine complex, dicyandiamine, and organic-acid hydrazide;

(v) Light-curing and ultraviolet-curing agents: diphenyliodonium hexafluorophosphate, triphenylsulfonium hexafluorophosphate.

An accelerator can be also used as known in the art. The accelerator for epoxy curing can be any of the following, for example: imidazole, 1-methylimidazole, 2-methylimidazole, 1,2-dimethylimidazole, 2-ethylimidazole, 1-vinylimidazole, 2-ethyl-4methylimidazole, N-(3-aminopropyl)imidazole.

In one embodiment, the composition further comprises at least one polymer precursor or polymer material, wherein the amount of the silica in the composition is about 20 wt. % or less, or about 10 wt. % or less, or about 5 wt. % or less, or about 1 wt. % or less, or about 0.1 wt. % or less, or about 0.05 wt. % or less. There is no particular lower amount of silica, but the amount of silica can be, for example, at least 0.01 wt. %, or at least 0.1 wt. %, or at least 1 wt. %. The amount of silica can be, for example, in the range of 0.01 wt. % to 20 wt. %, or 0.1 wt. % to 20 wt. %, or 0.1 wt. % to 10 wt. %, or 0.1 wt. % to 5 wt. %, or 0.1 wt. % to 1 wt. %. Other more preferred ranges include, for example, 0.01 wt. % to 5 wt. %, or 0.01 wt. % to 2 wt. %, or 0.01 wt. % to 1 wt. %, or 0.01 wt. % to 0.5 wt. %.

In some cases, advantage is found in use of less amounts of the silica. For example, compositions containing a low loading of the hollow organosilica interphase agent, for example, below 0.05 wt. %, can be especially useful.

### Properties

A variety of properties for the nanoparticles and composites are noted in the working examples section including particle morphology, thermal properties, and mechanical properties. The properties can be measured for a component before mixing with other components, or can be measured on a final material.

For example, nitrogen sorprtion characterization can be carried out. Porosity can be measured by nitrogen sorption studies, for example. For example, the surface area can be at least 100 m²/g, or at least 150 m²/g or at least 200 m²/g, or less than 500 m²/g, or less than 450 m²/g, or less than 400 m²/g, or in the range of 100 m²/g to 500 m²/g, or in the range of 150 m²/g to 400 m²/g.

The pore volume can be, for example, at least 0.3 cm³/g, or at least 0.5 cm³/g, or less than 1.0 cm³/g or less than 0.8 cm³/g, or in the range of 0.3 cm³/g to 1.0 cm³/g.

The pore size can be, for example, at least 10 nm, or at least 20 nm, or at least 25 nm, or at least 30 nm, or less than 100 nm, or less than 75 nm, or less than 50 nm, or in the range of 10 nm to 100 nm, or in the range of 20 nm to 75 nm.

In some embodiments, the materials can behave as spheres with small holes (e.g., smooth and not significantly porous or mesoporous).

### Methods of Making

Methods of making hollow particles are known as described in, for example, Lou et al., Adv. Mater. 2008, 20, 3987-4019, and references cited therein. Known methods include hard template synthesis, sacrificial templating synthesis, soft templating synthesis, and template-free methods. In a preferred embodiment, a template can be used, and the template can be hard or soft as known in the art. Hard templates are known and include, for example, monodisperse silica particles and polymer latex colloids. Other examples include carbon nanospheres and nanoparticles of metals and metal oxides. The template can be removed by etching to form a hollow structure.

The particles can be made by methods which include the core-shell template method and methods provided in the working examples. See, for example, Lou et al., Advanced Materials, 2008, 20, 3987-4019.

The methods of making also include functionalizing the particles whether on the inside, the outside, or both. In some embodiments, the outside of the particle is functionalized first followed by functionalization of the inside.

In addition to the method of making particles and composites, methods of shaping are also provided. For example, the compositions can be cured in molds including thin film molds. Molds can be used to prepare materials according to ISO standards.

### Articles, Devices, and Applications

The compositions and materials described herein can find applications in, for example, prepreg composites used in aerospace, military, automotive, and sporting goods.

Other areas of application include, for example, batteries, including lithium ion batteries; catalysis and sensing; and biomedical applications.

### Working Examples

Additional embodiments are provided in the following non-limiting working examples.

Chemicals.

Tetraethyl orthosilicate (TEOS) (≥99.0% (GC), Sigma-Aldrich), 1,2-Bis(triethoxysilyl)-ethane (BTEE) (96.0%, Sigma-Aldrich), Bisphenol A diglycidyl ether (an epoxy) (Epoxy equivalent weight 172-176, Sigma-Aldrich), hexahydro-4-methylphthalic anhydride (96.0%, mixture of cis and trans, Sigma-Aldrich), L-Arginine (99.0%, Sigma-Aldrich), LUDOX TM-40 colloidal silica (40.0 wt. % suspension in water, Sigma-Aldrich), (3-glycidyloxypropyl)trimethoxysilane (≥98.0%, Sigma-Aldrich), 1-methylimidazole (≥98.0%, Sigma-Aldrich), triethylamine ((≥99.0%, Sigma-Aldrich).

Mold Design for Making “Dog-Bone” Test Specimens.

The dimensions of “dog-bone” specimen type 1BA were designed following the BS EN ISO 572-2 standard.

Transmission Electron Microscopy (TEM).

Sample imaging was performed on a Titan G2 80-300 kV TEM (FEI Company) equipped with a 4 k×4 k CCD camera (model US4000) and an energy filter (model GIF Tridiem; Gatan, Inc.).

Nitrogen Sorption (BET).

Textual properties of hollow silica was measured by a nitrogen sorption analysis instrument (ASAP 2420, Micromeritics, USA). The surface of the sample was cleaned of water and simmering organic compounds by annealing under vacuum at 120° C. for 1.5 h prior to automatic analyzer analysis at temperature of liquid nitrogen (−196.15° C.).

Differential Scanning Calorimetry (DSC).

The estimated curing temperature with and without accelerator was monitored using a differential scanning calorimeter (NETZSCH DSC 204 F1 Phoenix). The sample was capped inside an aluminum pan and then heated from 30 to 550° C. in nitrogen gas with a heating rate of 10° C./min.

Density Measurement of the Composite Materials.

The density of the composite materials was determined using a density determination kit for Mettler Toledo Excellence XP205 analytical balance. The density of composite was deduced from the following equation:

$$ρ = \frac{A}{A - B} ( {ρ}_{0} - {ρ}_{L} ) + {ρ}_{L}$$

where ρ=density of composite sample, A=weight of composite in air, B=weight of composite in the water, ρ₀=density of water at measured temperature, and ρ_{L}=air density (0.0012 g/cm³).

Synthesis of Silica Core Templates.

To synthesize the silica cores with different diameters, first silica seed (14 nm in diameter) were produced by oil-water biphasic method. Deionized water (35 g), L-arginine (0.04 g), and TEOS (2.6 g) were added to a round-bottom flask (50 ml). This mixture was stirred (500 rpm) on a hot plate at 60° C. until the organic layer (TEOS) was disappeared (24 h). The diameter of this silica core measured by DLS was 11.4 nm. To synthesize 40 nm silica cores, deionized water (40 g), L-arginine (0.05 g), and TEOS (13 g) were added to the above 14 nm silica seed (10 g). This mixture was stirred (500 rpm) on a hot plate at 60° C. until the organic layer (TEOS) was disappeared (66 h). The diameter of this silica core measured by DLS was 44.5 nm. To synthesize 100 nm silica cores, deionized water (100 g), L-arginine (0.1515 g), and TEOS (30 g) were added to the 40 nm silica cores (50 g). This mixture was stirred (500 rpm) on a hot plate at 60° C. until the organic layer (TEOS) was disappeared (66 h). The diameter of this silica core measured by DLS was 120 nm.

Fabrication of Silica Shells on 40 nm Silica Cores (Core-Shell Particles).

Solution of 40 nm silica cores (50 ml) was added to deionized water (200 ml). L-arginine (0.2 g) and silica source for making silica shells (BTEE, 8.35 ml) were added to this mixture. This mixture was stirred (500 rpm) on a hot plate at 60° C. until the organic layer (BTEE) was disappeared (66 h).

Fabrication Silica Shells on 120 nm Silica Cores (Core-Shell Particles).

Solution of 120 nm silica cores (50 ml) was added to deionized water (200 ml). L-arginine (0.2 g) and BTEE (12.4 ml) were added to this mixture. This mixture was stirred (500 rpm) on a hot plate at 60° C. until the organic layer (BTEE) was disappeared (66 h).

Removal of Silica Cores.

The silica cores were removed by etching those with concentrated solution of sodium hydroxide. The organosilica shells were stable under these basic conditions. The solution of core-shell nanoparticles (260 ml) was added to the basic solution of sodium hydroxide (a mixture of 400 ml deionized water and 1.6 g sodium hydroxide). This mixture was stirred (1500 rpm) on a plate at 21° C. for 48 h. The hollow silica particles were poured into the dialysis tubes (Spectra/Por Dialysis Membrane MWCO 50,000) and then dialyzed against deionized water for 48 h. Fresh deionized water was replaced three times a day. The dry organosilica particles were obtained by removing the water by lyophilization.

Epoxide Functionalization of Hollow Silica.

Epoxy functional groups were introduced to silica (organosilica, LUDOX TM-40 silica) by reacting silica (2 g) with (3-glycidyloxypropyl)trimethoxysilane (1 ml) in the dried toluene (100 ml, dried by Zeolite 3A) with an addition of triethylamine (0.5 ml) at 90° C. for 12 h. The epoxy-functionalized silica was washed with toluene twice. The silica was isolated from toluene by using a vacuum filter through a PTFE membrane (TF-200, 0.2 μm pore size, 47 mm diameter). The quantity of silica and (3-glycidyloxypropyl)trimethoxysilane in reaction were calculated based on the assumption that silica had a maximum degree of hydroxylation (ca. 6.5 mmole OH g⁻¹)² and that one mole of (3-glycidyloxypropyl)trimethoxysilane reacted with three moles of OH.

Epoxy Curing and Fabrication of “Dog-Bone” Test Specimens.

A mixture of bisphenol A diglycidyl ether (7.1 g) and hexahydro-4-methylphthalic anhydride (4.6 g) was heated on a hot plate at 60° C. with stirring (1,500 rpm) for 40 min. Various amounts of epoxy functionalized silica were added to the mixture of epoxy/curing agent to have various loading amount of silica. This mixture, while heating at 60° C. with stirring (500 rpm), was sonicated for 5 min using a sonicator (BRANSON Digital Sonifier Model 450) with a tapered microtip. The sonication power was set at 10% with a pulse mode (on/off=5 s/5 s). The mixture after sonication was cooled down to 60° C. before adding 1-methylimidazole (0.1 ml) with stirring for 10 min. This composite mixture was degassed in a vacuum oven at 60° C. until there were not bubbles involved (ca. 5 min). The dog-bone mold was filled with this composite mixture at 60° C., and the composite-filled mold was degassed in a vacuum oven at 60° C. until there were not bubbles involved (ca. 60 min). During the degassing stage, the composite had to be refilled several times until the composite fully occupied the empty space in the mold. The degassed composite in the mold was cured at 90° C. for 16 h. The dog-bone specimens were removed from the mold and placed in an oven at 120° C. for 3 h (post-curing). A certain solvent could be used to assist the dispersion of nanoparticles in polymer matrix if the polymer matrix is highly viscous at processing temperatures. The use of solvent does not affect the dispersion of hollow nanoparticles because the density of hollow nanoparticles is light. The loading percentage of hollow silica varied from 0 to 20.0 wt. %.

The following formulations in Table 1 were used to test materials:

TABLE 1
Formulation of silica epoxy nanocomposite
to make test specimens for characterization

| | Bisphenol A | | | 1-methyl- |
|---|---|---|---|---|
| Silica wt. % | diglycidyl ether, g | Anhydride | Silica, g | imidazole, ml |
| 1 | 7.1 | 4.6 | 0.62 | 0.1 |
| 5 | 7.1 | 4.6 | 1.30 | 0.1 |
| 10 | 7.1 | 4.6 | 2.06 | 0.1 |
| 15 | 7.1 | 4.6 | 2.92 | 0.1 |
| 20 | 7.1 | 4.6 | 6.90 | 0.1 |

Anhydride (hardener): hexahydro-4-methylphthalic anhydride
Silica: Ludox TM-40, hollow organosilica (64 nm), or hollow organosilica (100 nm).

### Epoxy Curing and Fabrication of “Dog-Bone” Test Specimens, Procedure for Low Loading of HOSiO₂.

Hollow Silica:Epoxy nanocomposites were prepared over a range of mass fraction loading as follows: 0.010, 0.025, 0.050, 0.10, 0.25 and 0.5 wt %.

Epoxy resin (20 g), Huntsman Araldite LY564, was warmed to 45° C. using a conventional laboratory oven. To warm epoxy resin, hollow silica powder was added and the mixture mixed using a centrifugal vortex mixer, at 3500 rpm for 6 minutes. The epoxy curative, Huntsman Aradur 2954 (7 g) was then added to the silica:epoxy mixture and was mixed for a further 4 minutes. The mixture was then degassed using a vacuum chamber at 3 mBar for 25 minutes. The epoxy:silica nanocomposite mixture was then dispensed into dogbone type molds for mechanical and thermal analysis and were then cured over a conventional cure cycle consisting of 2 h at 60° C. followed by 6 h at 120° C. Cured nanocomposite samples were then removed from the molds and stored under vacuum in a desiccator prior to analysis.

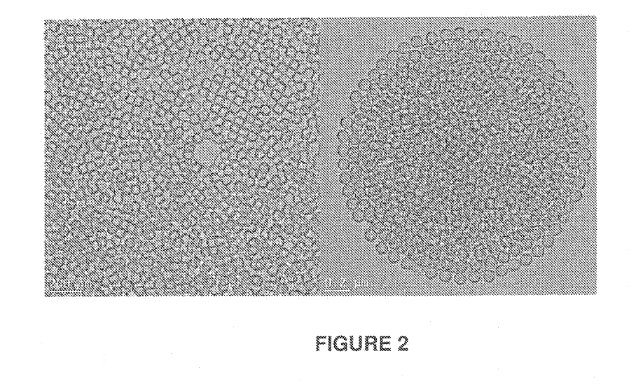

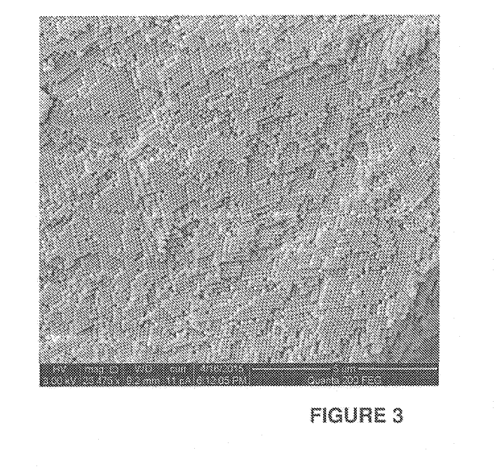

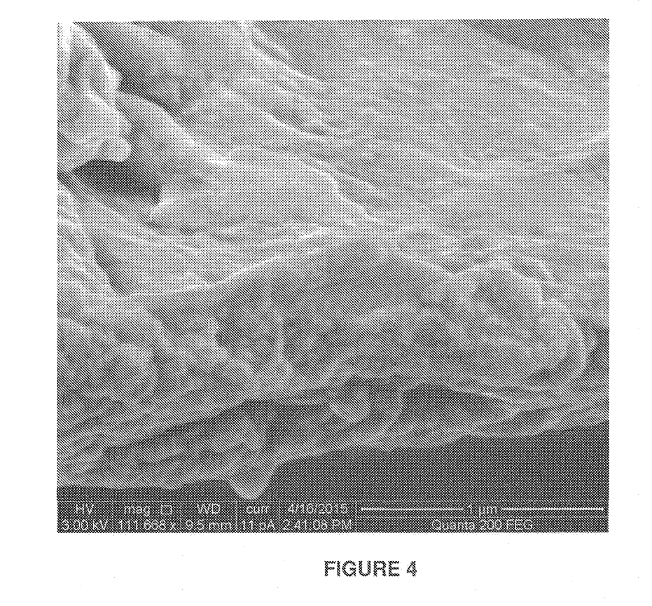

FIGS. 2-10 are now discussed further. FIGS. 2, 3, 4, and 5 show TEM, SEM, SEM, and TEM data, respectively. The particles appeared to be substantially spherical and relatively uniform. The micrographs in FIGS. 2 and 3 are for the particles without polymer precursor or polymer material present, whereas in FIG. 4 the polymer is present. FIG. 2 clearly showed the particles are hollow. FIG. 3 showed the formation of a structure similar to a colloidal crystal.

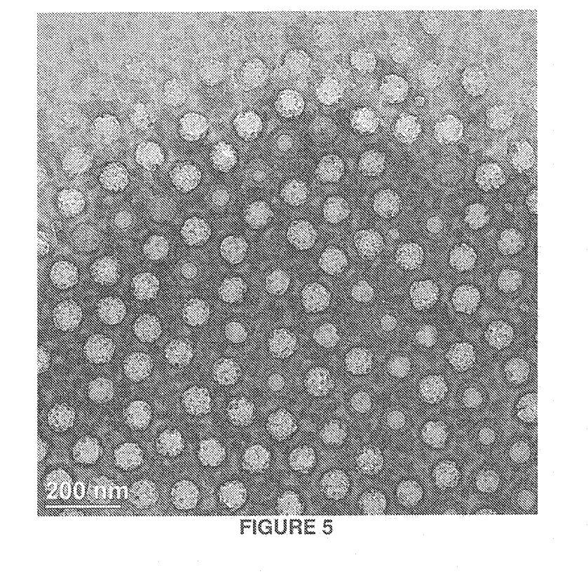

FIG. 5 is a TEM image of an ultra-thin slice (80 nm) of an epoxy-HOSiO2 composite material similar to the one in FIG. 4. Specifically, it is the material prepared via Procedure 2 (0.5 wt % loading of HOSiO₂ in Huntsman Araldite LY564). This figure shows that even after incorporation in the resin, the HOSiO2 particles stay substantially hollow. The image can explain why the density of the composite material stays low when the particles are added. Unexpectedly, nominally porous particles won't fill with resin when mixed in (due to viscosity/surface tension effects).

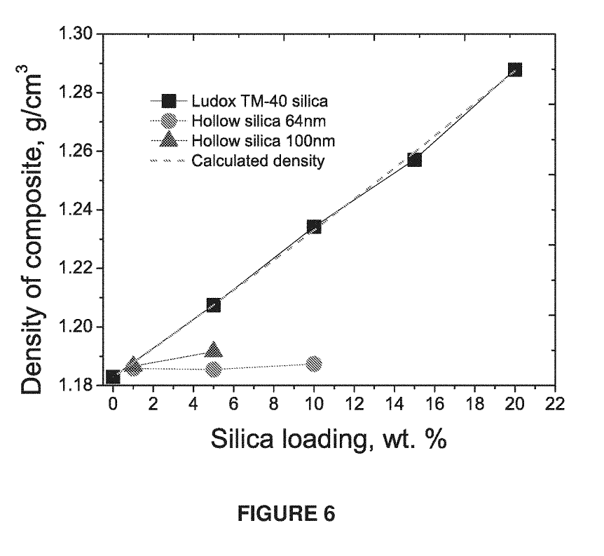

FIG. 6 shows the lightweight nature of the particle materials according to the claimed inventions. For example, for a 5 or 10 wt. % loading, the two samples according to the invention had density below 1.20 g/cc, far lower than the comparative composite. Moreover, the density did not increase as fast with higher loading for the hollow particles.

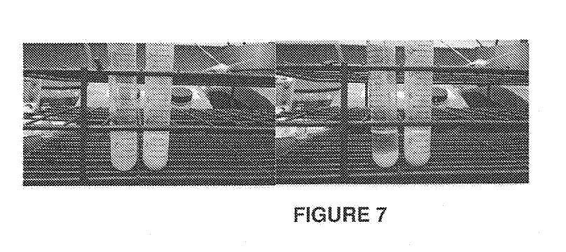

FIG. 7 shows the inventive particles on the left and the comparative particles on the right (sample correlated with third line of Table 1 for 10 wt. % silica). The inventive particles are far more stable in dispersion after standing overnight.

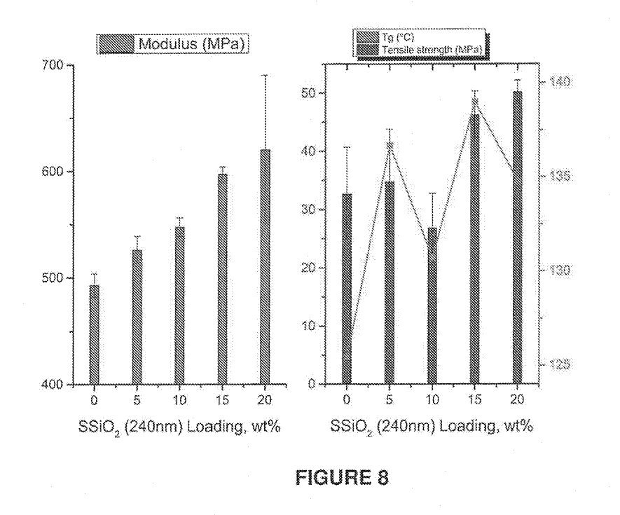

FIG. 8, which is comparative, showed that modulus increased with increasing amounts of silica. Tensile strength also increased with increasing amounts of silica, except an exception was the 10 wt. % data point. The glass transition temperature also increased with increasing amounts of silica compared to the material with no silica. The Tg for the 10 and 20 wt. % points was relatively lower compared to the 5 and 15 wt. % data points. The modulus of the (control) resin increased significantly with the increasing loading of silica. However, the ultimate tensile strength showed only a modest improvement, from ca. 32 to ca. 50 MPa. That required 20 wt % of control silica.

FIG. 8 relates to a different composite comprising non-hollow SiO₂. The phase behavior of this system and its properties are very different from our HOSiO₂ composite materials.

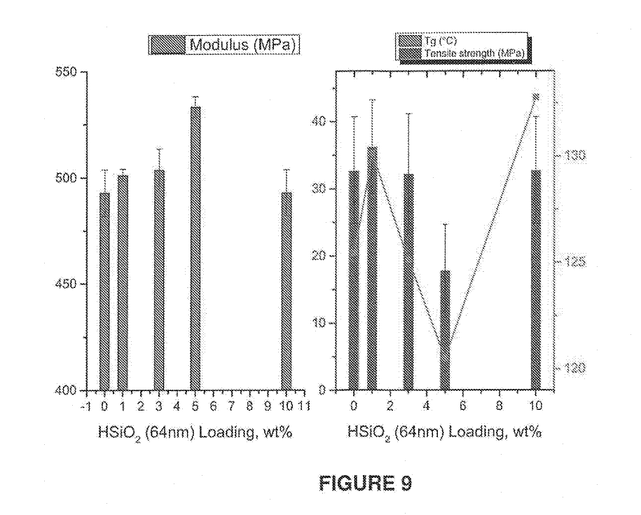

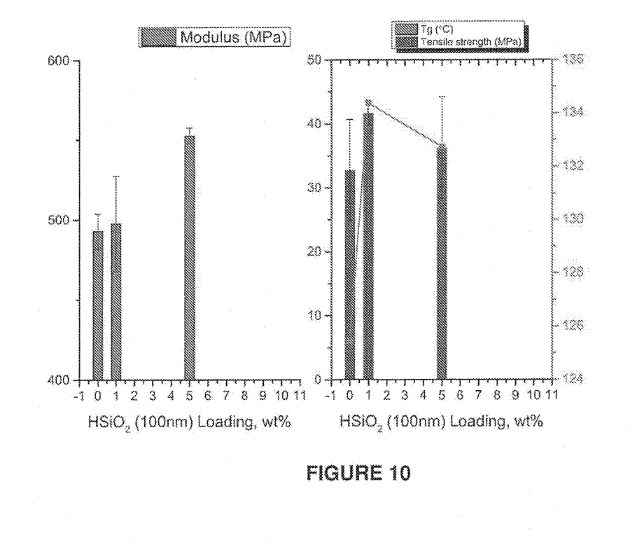

FIGS. 9 and 10 show changes in modulus and ultimate strength of the composite when 64 nm and 100 nm, respectively, hollow organo-silica particles were added. The resin here has been made via Procedure 1. Complex phase behavior is evident, with both modulus and ultimate strength changing non-linearly with hollow particle loading. It can be seen that addition of a small amount of silica (1%) led to modest improvements in modulus and UTS.

Based on the data above, we further chose to explore the behavior of the system at low loadings of hollow particles below 1 wt %.

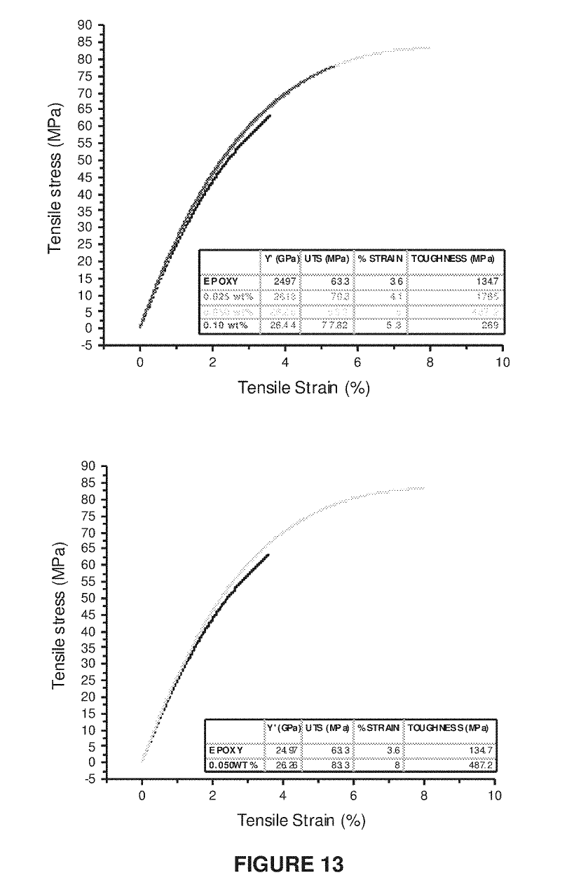

FIG. 13 shows the behavior of the composite prepared via Procedure 2 using Huntsman resin. Addition of 0.050 wt % of 100 nm hollow silica (same as FIG. 10) led to an approx. 3.6-fold increase in toughness, from 134.7 to 487.2 MPa; a 31.5% improvement in UTS, from 63.3 to 83.3 MPa; and a 2.2-fold improvement in ultimate strain, from 3.5 to 8%. The composition containing 0.050 wt % of hollow silica is optimal.

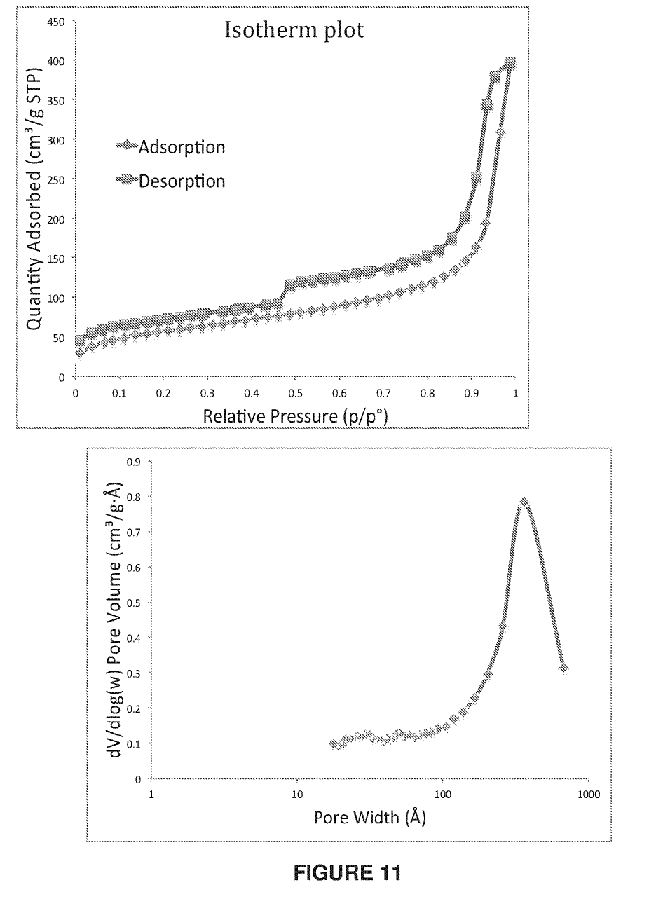

In FIG. 11, nitrogen testing is shown which provided the following characterization data:

Textural Results from Nitrogen Sorption:
Surface area: 202 m²/g
Pore volume: 0.61 cm³/g
Pore size: 36.4 nm (hollow void).

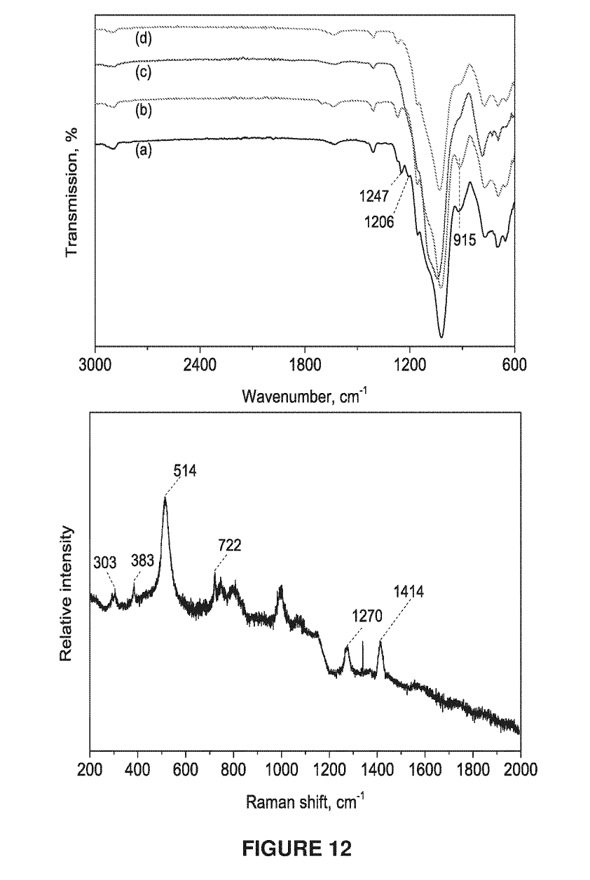

In FIG. 12, FT-IR and Raman spectra of the 100 nm hollow silica samples are shown. It can be seen that the epoxide groups on the surface remain intact and un-hydrolyzed after base etching of the internal SiO₂ cores.

1. A composition comprising:
hollow, substantially spherical silica particles having outside particle walls and inside particle walls, wherein the particles have an average particle size of about 10 nm to about 500 nm and an average wall thickness of about 5 nm to about 50 nm; and wherein the particles are functionalized with at least one organic functional group on the outside particle wall, on the inside particle wall, or on both the outside and inside particle walls, wherein the organic functional group is in a reacted or unreacted form.

2. The composition of claim 1, wherein the particles are functionalized with the organic functional group on the outside particle wall but not the inside particle wall.

3. The composition of claim 1, wherein the particles are functionalized with the organic functional group on the inside particle wall but not the outside particle wall.

4. The composition of claim 1, wherein the particles are functionalized with the organic functional group on both the outside particle wall and the inside particle wall.

5. The composition of claim 1, wherein the particles are functionalized with the organic functional group on both the outside particle wall and the inside particle wall and the organic functional group is the same for the outside and the inside particle walls.

6. The composition of claim 1, wherein the particles are functionalized with the organic functional group on both the outside particle wall and the inside particle wall and the organic functional group on the outside particle wall is different than the organic functional group on the inside particle wall.

7. The composition of claim 1, wherein the organic functional group is a reactive functional group or an unreactive functional group.

8. The composition of claim 1, wherein the organic functional group is a reactive functional group.

9. The composition of claim 1, wherein the organic functional group is an unreactive functional group.

10. The composition of claim 1, wherein the organic functional group is a reactive functional group but is in an unreacted form.

11. The composition of claim 1, wherein the organic functional group is a reactive functional group and is in a reacted form.

12. The composition of claim 1, wherein the organic functional group comprises a nitrogen or oxygen atom.

13. The composition of claim 1, wherein the organic functional group is epoxy, primary amino, secondary amino, imidazole, methacrylate, acrylate, urea, or fluorocarbon.

14. The composition of claim 1, wherein the organic functional group is covalently linked to the silica with a bivalent alkylene spacer.

15. The composition of claim 1, wherein the organic functional group is covalently linked to the silica with a bivalent ethylene or propylene spacer.

16. The composition of claim 1, wherein the composition further comprises at least one polymer precursor or polymer material, wherein the amount of the silica in the composition is about 10 wt. % or less.

17. A composite comprising at least one polymer material and hollow, substantially spherical silica particles having outside particle walls and inside particle walls, wherein the particles have an average particle size of about 10 nm to about 500 nm and an average wall thickness of about 5 nm to about 50 nm; and wherein the particles are functionalized with at least one organic functional group on the outside particle wall, on the inside particle wall, or on both the outside and inside particle walls, wherein the organic functional group is a reactive or unreactive functional group but is in a reacted form if a reactive functional group.

18. A prepreg composition comprising the composition of claim 1.

19. A method of making the composition comprising the particles of claim 1, the method comprising making the particles by a core-shell templating route.

20. An article comprising the composition comprising the particles of claim 1.
